(19) United States
(12) Patent Application Publication
(10) Pub. No.: US 2007/0283567 A1
(43) Pub. Date: Dec. 13, 2007

(54) Dual headed razor

(76) Inventor: Anthony J. Magli, Middlebury Center, PA (US)

Correspondence Address: LITMAN LAW OFFICES, LTD., P.O. BOX 15035, CRYSTAL CITY STATION, ARLINGTON, VA, 22215, US

(21) Appl. No.: 11/783,595

(22) Filed: Apr. 10, 2007

Related U.S. Application Data
(60) Provisional application No. 60/813,006, filed on Jun. 13, 2006.

(51) Int. Cl. B26B 21/00

(52) U.S. Cl. 30/50

(57) ABSTRACT

The dual headed razor includes a first razor blade assembly for shaving a user's face, or other desired area, in a conventional manner, along with a second razor blade assembly for trimming restricted areas, such as unwanted hair between the user's eyebrows, shaping a goatee or moustache, or trimming sideburns. The first and second razor blade assemblies are respectively mounted to first and second blade supports, which are respectively mounted to an upper end of a handle. The second blade support projects rearward from the handle 180° opposite the first blade support and is positioned above the first razor blade assembly. The second razor blade assembly has a width less than that of the first razor blade assembly.

### CROSS-REFERENCE TO RELATED APPLICATION

This application claims the benefit of U.S. Provisional Patent Application Ser. No. 60/813,006, filed Jun. 13, 2006.

### BACKGROUND OF THE INVENTION

1. Field of the Invention

The present invention relates to razors and devices for cutting facial hair and sideburns, and particularly to a dual headed razor having a first razor blade assembly having a wide blade and a second razor blade assembly with a narrow blade.

2. Description of the Related Art

Although razor blades and razor blade cartridges are manufactured in a wide variety of configurations, the width of razor blades and razor blade cartridges is typically standardized to approximately one inch. Most users find these standardized blades to be sufficient for shaving their faces, legs, underarms and other typically shaved body parts. However, some users may wish to shave areas on their bodies that are smaller than one inch in width. For example, many men wear goatees and mustaches, or have problems with hair growth between the eyebrows. Even clean-shaven men have problems trimming sideburns with a conventional razor between haircuts.

Conventionally, trimming such areas has required using a small pair of hair scissors. Alternatively, various electric trimmers are available that are advertised to trim goatees, mustaches, sideburns and the like. However, such electric trimmers often do not provide as close a shave as a razor blade. For this reason, barbers often follow up a trim with an electric razor by a finer shave with a straight razor blade. A conventional safety razor blade or cartridge is simply too large and unwieldy to provide the fine control necessary when trimming such restricted areas. Thus, a dual headed razor solving the aforementioned problems is desired.

### SUMMARY OF THE INVENTION

The dual headed razor includes a first razor blade assembly for shaving a user's face or other broad exposed areas in a conventional manner, along with a second razor blade assembly for trimming smaller or more delicate areas, such as unwanted hair between the user's eyebrows or shaping a goatee or moustache. The dual headed razor further includes a handle having opposed upper and lower ends and opposed front and rear surfaces.

The first and second razor blade assemblies are respectively mounted to upper ends of first and second blade supports, which are respectively mounted to the upper end of the handle. The first and second razor blade assemblies are preferably disposable safety razor blade cartridges, which are releasably secured to the respective upper ends of the first and second blade supports for removal, replacement and disposal thereof.

The second blade support projects from the handle 180° opposite the first blade support and is positioned above the first razor blade assembly, and so that the second razor blade assembly faces rearward, while the first razor blade assembly faces frontward. The positioning of the second smaller razor blade assembly above the first larger razor blade assembly allows the user to easily see both blade assemblies when the user is shaving with a mirror, without the larger blade assembly obscuring the user's vision of the smaller blade assembly. Preferably, the second razor blade assembly has a width less than that of the first razor blade assembly, allowing the second razor blade to be used for smaller and more delicate areas than the first razor blade assembly.

These and other features of the present invention will become readily apparent upon further review of the following specification and drawings.

### BRIEF DESCRIPTION OF THE DRAWINGS

FIG. 1 is an environmental, perspective view of a dual headed razor according to the present invention.

FIG. 2 is a side view of the dual headed razor according to the present invention.

FIG. 3 is a rear view of the dual headed razor according to the present invention.

FIG. 4 is a front view of the dual headed razor according to the present invention.

Similar reference characters denote corresponding features consistently throughout the attached drawings.

### DETAILED DESCRIPTION OF THE PREFERRED EMBODIMENTS

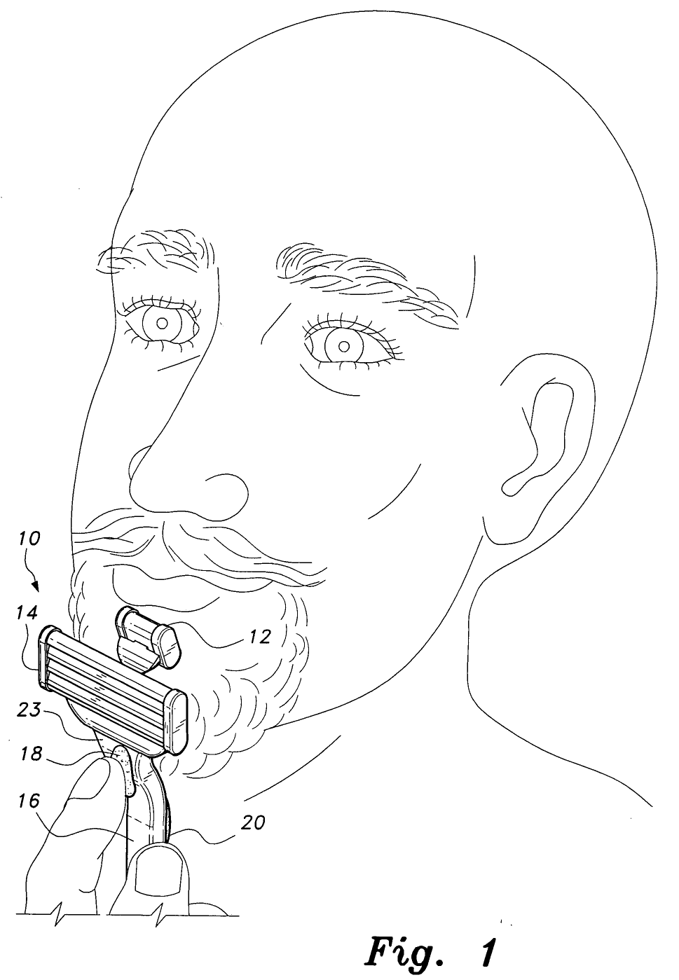

The present invention is directed towards a dual headed razor 10, as shown in FIG. 1. The dual headed razor 10 includes a first razor blade assembly 14 for shaving a user's face, or other desired area, in a conventional manner, along with a second razor blade assembly 12 for trimming smaller or more delicate areas, such as unwanted hair between the user's eyebrows, shaping a goatee or moustache, or trimming sideburns. Although shown as being utilized to shave the area between the user's lower lip and his goatee in FIG. 1, it should be understood that razor blade assemblies 12, 14 may be used to shave any desired portion of the user's body.

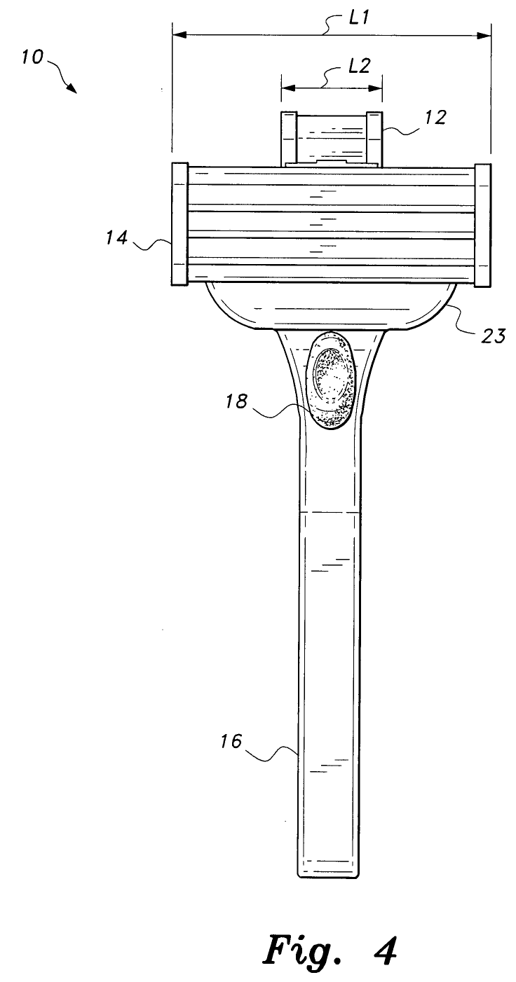

As shown in FIG. 4, the first razor blade assembly 14 has a first width L1 associated therewith, and the second razor blade assembly 12 has a second width L2 associated therewith. Preferably, L2 is less than L1, allowing the second razor blade assembly 12 to be used for trimming restricted areas on the user's body, such as between the user's eyebrows, or the space between the user's lower lip and beard or goatee.

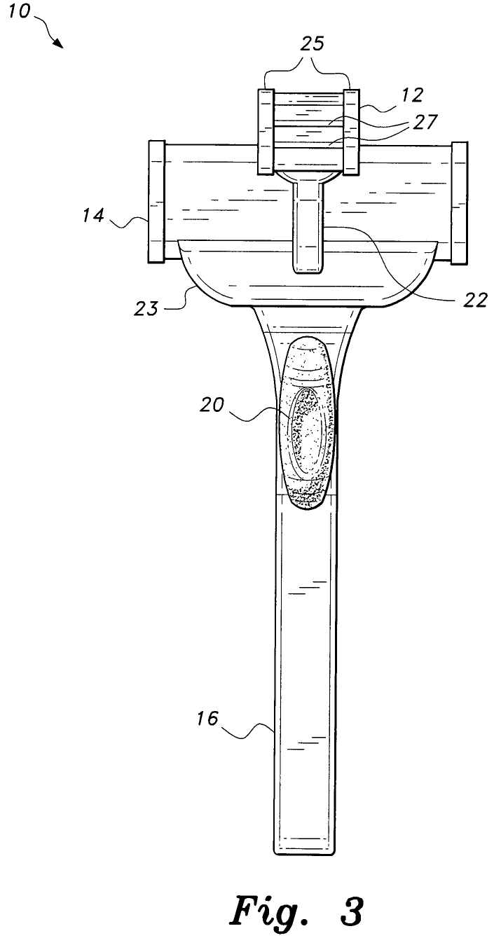

First and second razor blade assemblies 12, 14 are, in the preferred embodiment, disposable safety razor cartridges. As shown in FIG. 3, the exemplary second razor blade assembly 12 includes a pair of razor blades 27 mounted between a pair of opposed sidewalls 25. The number of razor blades within cartridge 12 and the dimensions of sidewalls 25 are dependent upon the width of the cartridge and the user's preference.

Although a cartridge is preferred, it should be understood that first and second razor blade assemblies 12, 14 may comprise single safety razor blades mounted on a suitable head. The disposable razor blade cartridges 12, 14 may further include shaving lotion applicators or any other desired elements commonly associated with disposable razor blade cartridges.

In the preferred embodiment, first razor blade assembly 14 is a conventional disposable razor blade cartridge, which is releasably mounted to an upper end of first blade support 23. The width L1 of first cartridge 14 is preferably approximately one inch. Preferably, the width L2 of second cartridge 12 is between about one-third to one-half of L1.

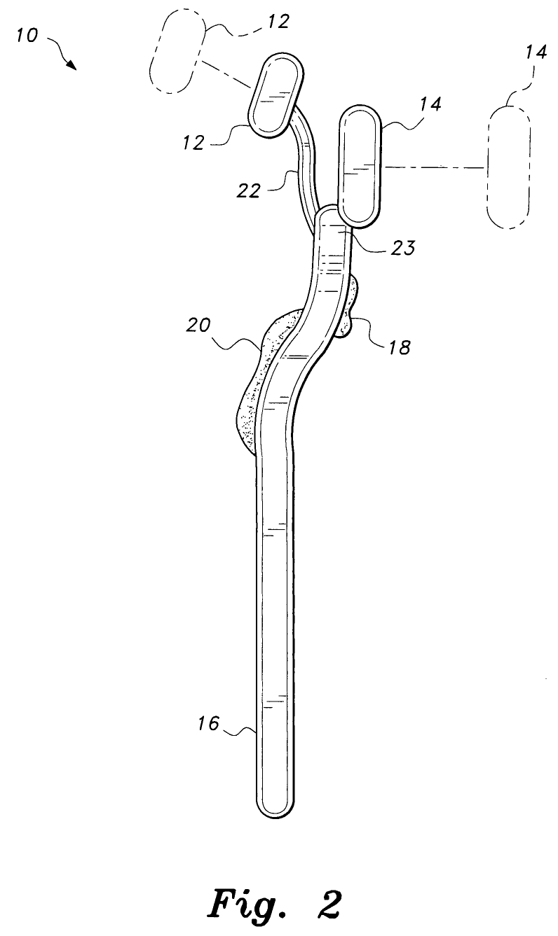

The dual headed razor includes a handle 16 having opposed upper and lower ends and opposed front and rear surfaces. A first gripping member 18 is mounted to the front surface of handle 16 and a second gripping member 20 is mounted to the rear surface of handle 16. Gripping members 18, 20 are preferably formed from a material having a high coefficient of friction, such as rubber, allowing the user to securely grasp handle 16 when shaving with razor 10. As shown, each gripping member 18, 20 includes a concave depression for receiving the pad of one of the user's fingers. Further, as best shown in FIG. 2, the center of gripping member 18 is preferably positioned slightly above the center of gripping member 20. In the preferred embodiment, gripping member 18 has a height approximately ⅔ the height of gripping member 20, though it should be understood that the particular size and positioning of gripping members 18, 20 may be adjusted for ergonomic preference.

As best shown in FIG. 2, first blade support 23 is mounted to the upper end of handle 16 and, preferably, projects forward therefrom. Second blade support 22 is also mounted to the upper end of handle 16 and preferably projects rearward therefrom 180° opposite first blade support 23, as shown. The engaging surface of first razor blade assembly 14 faces forward and the engaging surface of second razor blade assembly 12 faces rearward. Thus, in use, the user may shave in a conventional manner with first razor blade assembly 14 being positioned adjacent the user's skin. When the user wishes to shave with the smaller, second razor blade assembly 12, the user rotates the handle by 180° about the longitudinal axis thereof, so that second razor blade assembly 12 is positioned adjacent the user's skin. First and second gripping members 18, 20 are formed on both the front and rear surfaces of handle 16 so that the user may securely grasp handle 16 when using either the first or second razor blade assemblies 14, 12.

First and second razor blade assemblies 14, 12 may be releasably locked to the respective first and second blade supports 23, 22 so that the razor blade assemblies may be removed, replaced and disposed of, following usage. It is to be understood that the razor blade assemblies 14, 12 do not have to be disposed of simultaneously. First razor blade assembly 14 may be pivotally mounted to first blade support 23, in a conventional manner. Similarly, second razor blade assembly 12 may be pivotally mounted to second blade support 22. However, in the preferred embodiment, the second blade support 22 is formed from a flexible and resilient material, allowing both the second blade assembly 12 and the second blade support 22 to pivot with respect to the handle 16, such that second blade assembly 12 maintains continuous contact with the user's body during shaving, providing a smooth, comfortable and continuous shave. In the preferred embodiment, second blade support 22 is elastically flexible, thus removing the need for a separate pivotal mount between the handle 16 and the second razor blade assembly 12.

As best shown in FIG. 2, second razor blade assembly 12 is preferably positioned above first razor blade assembly 14. Thus, during the trimming of small or delicate areas, when the user is shaving with second razor blade assembly 12, the first razor blade assembly 14 does not get in the way of either the body part to be shaved or the user's hand. Similarly, the positioning of second razor blade assembly 12 above the first razor blade assembly 14 allows for firm and secure grasping and usage of the razor 10 when the user is shaving with first razor blade assembly 14. Further, this positioning allows for a larger range of pivotal motion for second blade support 22 with respect to handle 16, providing the user with a closer and smoother shave. The positioning of second razor blade assembly 12 above first razor blade assembly 14 allows the user to clearly see the position of the respective razor blade assemblies when shaving in the mirror, without the larger razor blade assembly 14 obscuring the user's view of the smaller razor blade assembly 12.

It is to be understood that the present invention is not limited to the embodiments described above, but encompasses any and all embodiments within the scope of the following claims.

I claim:

1. A dual headed razor, comprising:
a handle having opposed upper and lower ends, and opposed front and rear surfaces;
a first blade support extending from the upper end of the handle, the first blade support having a first blade mount defining a first width, the first blade mount being adapted for mounting a first razor blade assembly; and
a second blade support extending from the upper end of the handle 180° opposite the first blade support, the second blade support having a second blade mount defining a second width, the second blade mount being adapted for mounting a second razor blade assembly, the second width being less than the first width, the second blade support extending to a greater height than the first blade support, whereby the second blade assembly is raised above the first razor blade assembly when the assemblies are mounted thereon and the second razor blade is adapted for shaving relatively narrow and delicate areas.

2. The dual headed razor as recited in claim 1, wherein said second blade support is flexible and elastically pivots with respect to said handle.

3. The dual headed razor as recited in claim 1, wherein the first and second razor blade assemblies each comprise disposable razor blade cartridges releasably mounted to the first and second blade mounts, respectively.

4. The dual headed razor as recited in claim 1, further comprising first and second gripping members secured to the front and rear surfaces of said handle, respectively, the first gripping member being positioned adjacent the first blade support and the second gripping member being positioned adjacent the second blade support.

5. The dual headed razor as recited in claim 4, wherein the first and second gripping members each include a central region, the central region of the first gripping member being positioned above the central region of the second gripping member with respect to said handle.

6. The dual headed razor as recited in claim 5, wherein the central regions of the first and second gripping members each have a substantially concave depression formed therein.

7. The dual headed razor as recited in claim 4, wherein each of the first and second gripping members has a height associated therewith, the height of the first gripping member being less than the height of the second gripping member.

8. The dual headed razor as recited in claim 7, wherein the height of the first gripping member is approximately two-thirds the height of the second gripping member.

9. The dual headed razor as recited in claim 1, wherein the second width of the second blade mount is between about one-third and one-half the first width of the first blade mount.

10. The dual headed razor as recited in claim 9, wherein the first and second razor blade assemblies each comprise disposable razor blade cartridges releasably mounted to the first and second blade mounts, respectively, the first and second razor blade assemblies each having a first and second blade width associated therewith, the second blade width being between approximately one-third and approximately one-half the first blade width.
